(19) United States
(12) Patent Application Publication
(10) Pub. No.: US 2014/0068519 A1
(43) Pub. Date: Mar. 6, 2014

(54) PHONEBOOK PROVISION METHOD AND APPARATUS

(71) Applicants: SNU R&DB FOUNDATION, Seoul (KR); Samsung Electronics Co., Ltd., Gyeonggi-do (KR)

(72) Inventors: Hoongon NAM, Seoul (KR); Myungsoo KIM, Gyeonggi-do (KR); Hyunjoon KIM, Seoul (KR); Yongwoon PARK, Seoul (KR); Chulwoo YANG, Seoul (KR); Jeeman LEE, Seoul (KR); Eunjin YU, Gyeonggi-do (KR)

(73) Assignees: SNU R&DB FOUNDATION, Seoul (KR); Samsung Electronics Co., Ltd., Gyeonggi-do (KR)

(21) Appl. No.: 14/012,001

(22) Filed: Aug. 28, 2013

(30) Foreign Application Priority Data
Aug. 28, 2012 (KR) 10-2012-0094019

(51) Int. Cl. G06F 3/0481

(52) U.S. Cl. CPC G06F 3/04817
USPC 715/838; 715/835

(57) ABSTRACT

A phonebook provision method and apparatus of a portable terminal is disclosed for providing a user with a phonebook of contacts. The phonebook provision method of a terminal having a touchscreen may include detecting a first event requesting for displaying a relationship diagram including icons corresponding to contacts that are connected through lines and displaying a first relationship diagram read from a storage unit of the terminal on a touchscreen in response to the first event.

### CLAIM OF PRIORITY

This application claims the benefit under 35 U.S.C. §119(a) of a Korean patent application filed on Aug. 28, 2012 in the Korean Intellectual Property Office and assigned Serial No. 10-2012-0094019, the entire disclosure of which is hereby incorporated by reference.

### BACKGROUND

1. Field of the Invention

The present disclosure relates to a phonebook provision method and apparatus of a portable terminal for providing the user with a phonebook of contacts.

2. Description of the Related Art

Typically, a portable terminal is used as a medium of radio voice communication and information exchange. With technological advances, the portable terminal, which was originally a medium providing radio communication service, has been developed to a great extent and now provides diverse services and functions. For example, the portable terminal may provide such diverse functions as that of a phonebook, game, short message, email, morning call, music player, schedule organizer, digital camera, and wireless Internet access device.

Typically, a portable terminal user manages the contacts of acquaintances (e.g. phone numbers, email addresses, etc.) by using a phonebook that is embedded in the portable terminal. The conventional portable terminal provides the phonebook in the form of a list of contacts sorted in alphabetical order. Accordingly, it is not easy for the user of a conventional portable terminal to intuitively check the relationships with the acquaintances represented by the contacts.

### SUMMARY

In an embodiment of the present invention, a phonebook provision method and apparatus are provided that are configured to check the relationships between the acquaintances represented by the contacts intuitively.

In accordance with an aspect of the present invention, a phonebook provision method of a terminal having a touchscreen includes detecting a first event requesting for displaying a first relationship diagram including icons corresponding to contacts that are connected through lines, and displaying the first relationship diagram read from a storage unit of the terminal on the touchscreen in response to the first event.

In accordance with another aspect of the present invention, a terminal includes a touchscreen; a storage unit which stores one or more contacts and at least one relationship diagram including icons corresponding to the contacts that are connected through lines; a radio communication unit which establishes a communication link with another terminal represented by one of the contacts corresponding to one of the icons when selected by the user; and a control unit which controls the touch screen, the storage unit, and the radio communication unit, wherein the control unit controls detecting a first event requesting for displaying the at least one relationship diagram and displaying the at least one relationship diagram read from the storage unit of the terminal on the touchscreen in response to the first event.

These and other aspects of the present invention are more fully described hereinbelow.

### BRIEF DESCRIPTION OF THE DRAWINGS

FIG. 1 is a block diagram illustrating the configuration of the phonebook provision apparatus according to an embodiment of the present invention;

FIG. 2 is a flowchart illustrating the relationship diagram presentation procedure of the phonebook provision method according to an embodiment of the present invention;

FIGS. 3A, 3B, 3C and 3D are diagrams illustrating exemplary screen images for explaining the procedure of presenting the relationship diagram in the phonebook provision method according to an embodiment of the present invention;

FIG. 4 is a flowchart illustrating the procedure of placing a call using the relationship diagram in the phonebook provision method according to an embodiment of the present invention;

FIG. 5 is a diagram illustrating an exemplary screen image for explaining the procedure for placing a call based on relationship diagram in the phonebook provision method according to an embodiment of the present invention;

FIG. 6 is a flowchart illustrating the relationship diagram update procedure of the phonebook provision method according to an embodiment of the present invention;

FIGS. 7A and 7B are diagrams illustrating exemplary screen images for explaining the relationship diagram update procedure of the phonebook provision method according to an embodiment of the present invention;

FIG. 8 is a flowchart illustrating a relationship diagram update procedure of the phonebook provision method according to another embodiment of the present invention; and

FIGS. 9A and 9B are diagrams illustrating exemplary screen images for explaining the relationship diagram update procedure of the phonebook provision method according to another embodiment of the present invention.

### DETAILED DESCRIPTION

Terms and words used in the specification and claims are to be regarded as concepts selected by the inventor as the best method of describing the present invention, and are to be interpreted as having meanings and concepts adapted to the scope and spirit of the present invention to understand the technology of the present invention. Therefore, the exemplary embodiments described in the specification and the constructions illustrated in the drawings correspond to only the most preferable embodiments, but do not represent all of the technical spirit of the present invention. It is therefore to be understood that numerous modifications may be made to the illustrative embodiments and that other arrangements may be devised without departing from the spirit and scope of the present invention as defined by the appended claims. In the drawings, certain elements may be exaggerated or omitted or schematically depicted for clarity of the invention, and the actual sizes of the elements are not reflected. Thus, the present invention is not limited to the relative sizes of the elements illustrated in the drawings and distances therebetween.

The phonebook provision method and apparatus according to an embodiment of the present invention provides the user with a relationship diagram that intuitively shows the relationships between the acquaintances represented by the contacts. A relationship diagram (interchangeably referred to as organization chart and structural chart) can be provided per group (e.g. family, friend, association, office, etc.). The phonebook provision method and apparatus according to an embodiment of the present invention may be configured to create and edit the relationship diagram according to the user's taste and save the customized relationship diagram. The phonebook provision method and apparatus according to an embodiment of the present invention may be configured to place a call (e.g. voice call, video call, text messaging, etc.) to the acquaintance corresponding to the contact selected on the relationship diagram.

The phonebook provision method and apparatus according to an embodiment of the present invention includes a display unit for displaying the relationship diagram, an input unit for the user to input commands for creating and editing the relationship diagram, a storage unit for storing the relationship diagram, and a communication unit for communicating with an external device. Particularly in an embodiment of the present invention, the phonebook provision method and apparatus is capable of being applied to various types of terminals such as smartphone, tablet PC, and laptop PC.

The phonebook provision method and apparatus of the present invention are described in greater detail hereinbelow. However, for clarity and simplicity, detailed descriptions of the well-known functions and constructions which are determined to make the spirit of the present invention unclear will be omitted.

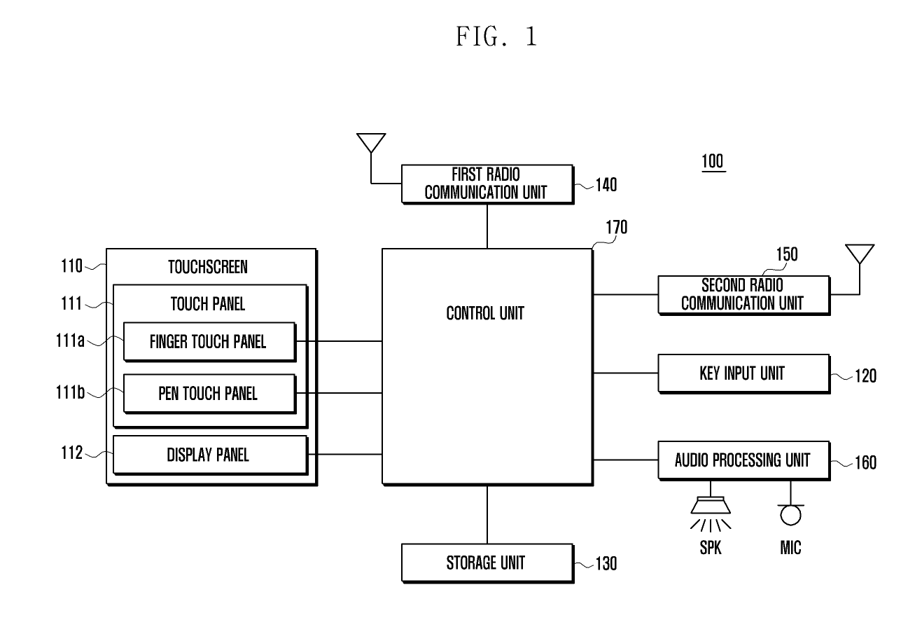

FIG. 1 is a block diagram illustrating the configuration of the phonebook provision apparatus according to an embodiment of the present invention.

Referring to FIG. 1, the phonebook provision apparatus 100 according to an embodiment of the present invention includes a touchscreen 110, a key input unit 120, a storage unit 130, a first radio communication unit 140, a second radio communication unit 150, an audio processing unit 160, a speaker (SKP), a microphone (MIC), and a control unit 170.

The touchscreen 110 is responsible for providing interference for interaction with the user and includes a touch panel 111 and a display panel 112. The touch panel 111 can be placed on the display panel 112. In detail, the touch panel 111 can be implemented in one of an add-on type for placing in on the display panel 112 and an on-cell type or in-cell type for embedding the touch panel 111 in the display panel 112.

The touch panel 111 generates an analog signal in response to a gesture (e.g. touch event) made by the user on the touch panel 111. The analog signal is converted to a digital signal through A/D conversion and then transferred to the control unit 170. The control unit 170 detects the user's gesture based on the received signal. That is, the control unit 170 is capable of checking the touch position, touch movement distance, touch movement direction, touch movement speed, and touch pressure; and controlling the components based on the check result.

The touch panel 111 can be an integral touch panel including a finger touch panel 111a for detecting a finger gesture and a pen touch panel 111b for detecting a pen gesture. The finger touch panel 111a may be configured as a capacitive type. The finger touch panel 111a may generate a touch event in response to a gesture made with an object (e.g. a conductive material capable of causing change in capacitance) as well as the user's finger touch gesture. That is, the finger touch panel 111a may generate a touch event interactive to a certain object as well as user's hand. The finger touch panel 111a may also or instead be implemented as a resistive type, Infrared (IrDA) type, and microwave type. The pen touch panel 111b can be implemented in electromagnetic induction type. In this case, the pen touch panel 111b may generate a touch event in response to the gesture made by a touch stylus pen manufactured for forming a magnetic field.

As described above, the user's touch gesture can be classified into one of a finger gesture and a pen gesture according to the means used for making the gesture on the touchscreen 110. As described above, the finger touch gesture may be detected by the finger touch panel 111a, and the pen touch gesture may be detected by the pen touch panel 111b. The user's gesture is also can be differentiated between touch and touch gesture regardless of the touch means (e.g. finger and stylus pen). The touch gestures include tap, double tap, long tap, drag, drag & drop, flick, press, etc. Here, ‘touch’ is a user's gesture of contacting a position on the screen with a touch means, ‘tap’ is a user's gesture of contacting a position on the screen with a touch means and releasing the contact (touch-off) without moving the touch means, ‘double tap’ is a user's gesture of making the tap twice, ‘long tap’ is a user's gesture of maintaining the contact for a long time as compared to the tab and then releasing the contact, ‘drag’ is a user's gesture of contacting a position and moving the contact on the screen in a certain direction, ‘drag and drop’ is a user's gesture of making the drag gesture and then release the contact of the touch means, ‘flick’ is a user's gesture of snapping on the screen quickly as compared to the drag gesture, and ‘press’ is a user's gesture of contacting at a certain position on the screen and applying press. That is, ‘touch’ denotes the state of maintain contact on the screen, and ‘touch gesture’ denotes the behavior of making the contact (touch-on) and then releasing the contact (touch-off). The touch panel 111 is capable of including a pressure sensor for detecting the press applied at the touched position. The detected pressure information is transferred to the control unit 170, and the control unit 170 discriminates between touch and press based on the pressure information.

The touch panel 112 converts the video data input by the control unit 170 to analog signal to display an image under the control of the control unit 170. That is, the display panel 112 may display diverse screens associated with the use of the phonebook provision apparatus such as lock screen, home screen, application execution screen, and keypad. The lock screen is of the screen image displayed when the display panel 112 powers on. If a user's gesture for unlocking the screen, the control unit 170 may change the lock screen for the home screen or an application execution screen. The home screen is of the screen image including plural icons corresponding to the respective applications. If one of the icons is selected by the user (e.g. if phonebook application is tapped), the control unit 170 executes the application corresponding to the icon and controls the display panel 112 to displaying the execution screen (e.g. relationship diagram). The display panel 112 may display a first screen (e.g. relationship diagram) among the screens along with a second screen (e.g. keypad or menu) at a part on the first screen. Here, the second screen can be presented with semitransparency. The display panel 112 may display multiple screens under the control of the control unit 170. For example, the display panel 112 may display the keypad in a first screen area while displaying the relationship diagram in a second screen area of the touchscreen 110. By way of illustration only, the display panel 112 can be implemented as one of the following: Liquid Crystal Display (LCD), Organic Light Emitted Diode (OLED), and Active Matrix OLED (AMOLED).

The key input unit 120 may be provided with a plurality of keys (buttons) for receiving alphanumeric information and configuring various functions. The function keys may include menu keys, screen on/off key, power on/off key, and volume control key, etc. The key input unit 120 may generate a key event to the control unit 170 in association with user setting and function control of the apparatus 100. The key events may include power on/off event, volume control event, screen on/off event, etc. The control unit 170 controls the components in response to these key events. The keys (buttons) of the key input unit 120 are referred to as hard keys while the keys (buttons) provided on the touchscreen 110 are referred to as soft keys.

The storage unit is a secondary memory unit such as NAND flash memory. The storage unit 130 may store the data generated in the apparatus 100 (e.g. text message and picture taken with the embedded camera) or received from outside by means of the radio communication unit 140 (e.g. text message and email) under the control of the control unit 170. The storage unit 130 may alternatively or additionally store the lock screen, home screen, keypad, phonebook, relationship diagram, etc. The storage unit 130 may alternatively or additionally store various settings associated with the operations of the apparatus 100 (e.g. brightness of the touchscreen and touch vibration on/off).

The storage unit 130 may store an Operating System (OS) for booting up the apparatus 100, communication program, image processing program, display control program, user interface program, embedded applications, and/or third party applications. The communication program includes commands for communication with an external apparatus by means of the radio communication unit 140. The graphic processing program includes various software components such as image format conversion, graphics size adjustment, rendering, and display panel's backlight luminance determination modules. Here, the graphics may include text, webpage, icon, picture, motion picture, and animation. The graphics processing program may include a software codec. The user interface program may include various software components associated with the user interface. The voice recognition program is capable of extracting voice property information (e.g. voice tone, frequency, decibel, etc.) from the voice data. The embedded applications are the applications installed in the apparatus basically. The embedded applications may include browser, email, instant messenger, and/or phonebook applications. According to an embodiment of the present invention, the phonebook application can be a third party application. The third party applications are the applications downloaded from an online market for installation in the apparatus 100. There can be various third party applications. The third party applications can be installed and uninstalled freely. If the apparatus 100 powers on, the booting program is loaded on the main storage (e.g. RAM) of the control unit 170. The booting program loads the OS of the apparatus 100 on the main storage. The OS loads various application programs on the main storage for execution. Since the system booting and program loading are well-known processes, detailed descriptions thereon are omitted herein.

The first and second radio communication units 140 and 150 are responsible for radio communication with external devices. The first radio communication unit 140 is capable of supporting at least one of Global System for Mobile Communication (GSM) network, Enhanced/data GSM Environment (EDGE) network, Code Division Multiple Access (CDMA) network, Wideband CDMA (WCDMA) network, and Orthogonal Frequency Division Multiple Access (OFDM) network. The second radio communication unit 150 is capable of supporting Wireless Local Area Network (Wi-Fi). The second radio communication unit 150 is also capable of including a first band communication module and a second band communication module for transmitting/receiving signals on different frequency bands. For example, the first and second communication modules can be configured to support 2.4 GHz band and 5 GHz band communications. Of course, the frequency bands can be changed depending on the system design. Accordingly, the second radio communication unit 150 is capable of receiving the first frequency band signal from a first external terminal directly or via an Access Point (AP) while transmitting the second frequency band signal to a second eternal terminal directly or via an Access Point (AP). The second radio communication unit 150 is also capable of transmitting or receiving the first and second band signals simultaneously. The first and second frequency bands may be identical to or different from each other. In this case, the first and second frequency bands may be configured orthogonally without overlapping. For example, the first and second frequency bands may be configured on the 2.4 GHz band. The 2.4 GHz band consists of 14 channels with interval of 5 MHz, and each channel has the bandwidth of 22 MHz. In the case that the channels 1, 6, and 11 are non-overlapping, the first frequency band is determined for channel 1 while the second frequency band for channel 6 or 11.

The audio processing unit 160 is connected with the speaker (SPK) and the microphone (MIC) and processes audio input and output for supporting voice recognition, voice recording, digital recording, and telephony functions. The audio processing unit 160 receives the audio data output from the control unit 170, converts the audio data to an analog signal, and outputs the analog signal through the speaker (SPK). The audio processing unit 160 receives the analog signal input through the microphone, converts the analog signal to audio data, and transfers the audio data to the control unit 170. The speaker (SPK) converts the analog signal from the audio processing unit 160 to output an audible sound wave. The microphone (MIC) converts the voice and other sound waves to an analog signal.

The control unit 170 controls overall operations of the apparatus 100 and signaling among the internal components of the apparatus 100 and processes data. The control unit 170 may include a main storage for storing the OS and application programs, a cache memory for storing data read from the storage unit 130 temporarily, a Central Processing Unit (CPU), and a Graphic Processing Unit (GPU). Here, the OS is responsible for providing interface among the programs and manage the computer resource such as CPU, GPU, main storage, and auxiliary storage devices. That is, the OS operates the apparatus 100, determines the task order, and controls operations of the CPU and GPU. The OS is also responsible for controlling the application program execution and managing the storage of the data and files. As well-known, the CPU is a core control unit of a computer system for data operation and comparison and command interpretation and execution. The GPU is the graphic control unit for performing graphic-related data operation and comparison and command interpretation and execution instead of the CPU. Each of the CPU and GPU can implemented in the form of a package by integrating two or more independent cores into a single integrated circuit (e.g. quad-core). The CPU and GPU may be integrated in the form of System on Chip (SoC). The CPU and GPU also may be packaged as a multi-layer unit. The integrated CPU and GPU structure can be referred to as Application Processor (AP). In one embodiment of the present invention, the control unit 170 is provided with a function of providing the relationship diagram. This function is described in detail with reference to other drawings.

Although not illustrated herein, the apparatus 100 according to an embodiment of the present invention may further include at least one of GPS module, Bluetooth module, Near Field Communication (NFC) module, vibration motor, camera, acceleration sensor, gyro sensor, wired communication module for communication with external devices (e.g. PC), and their equivalents. Also, the internal component of the apparatus 100 can be selectively omitted or replaced with their equivalents depending on the implementation type.

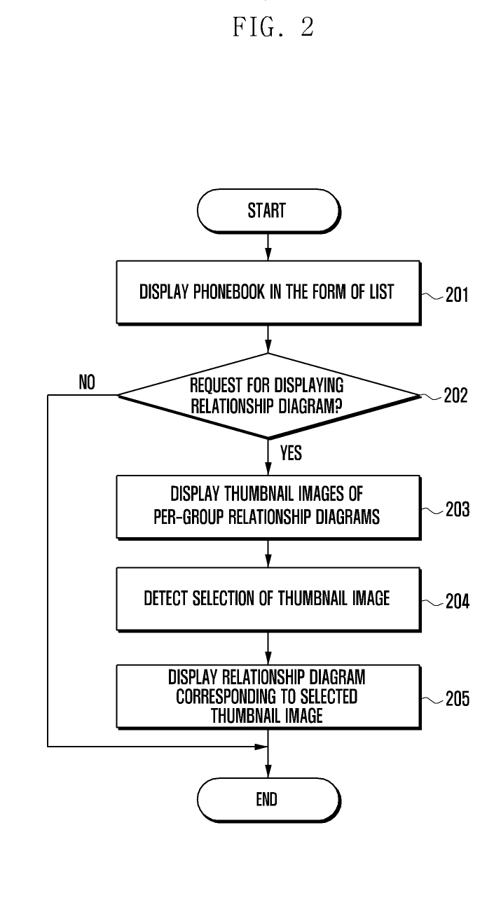

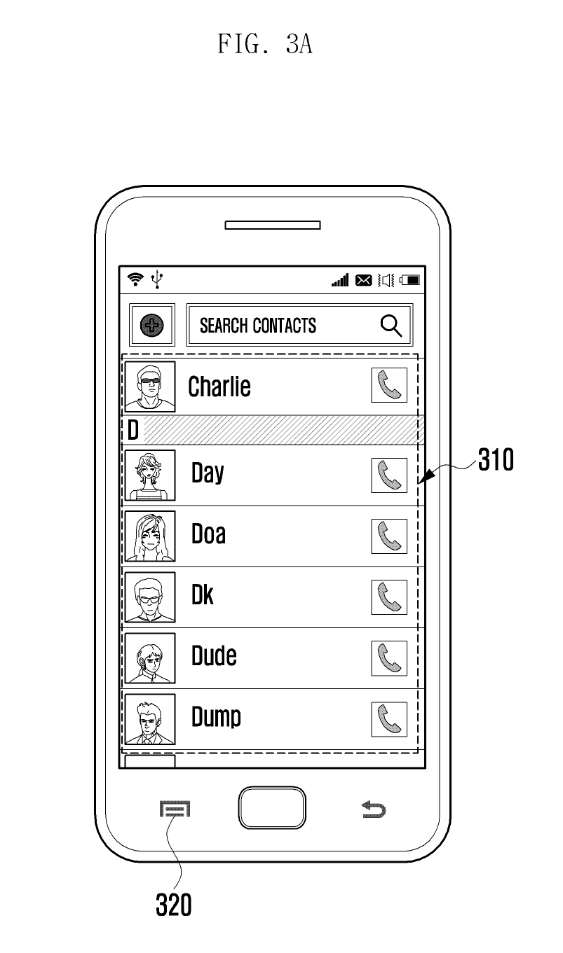

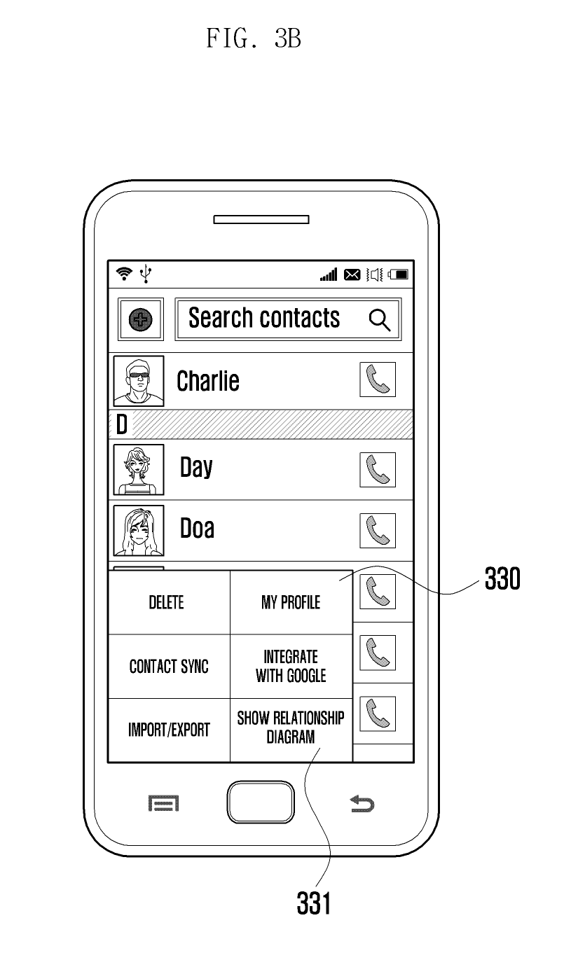

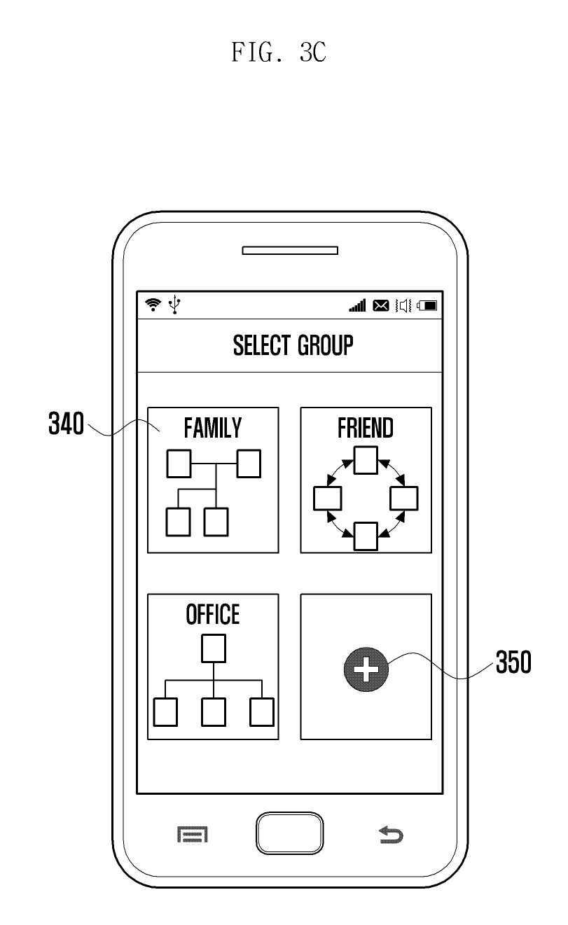

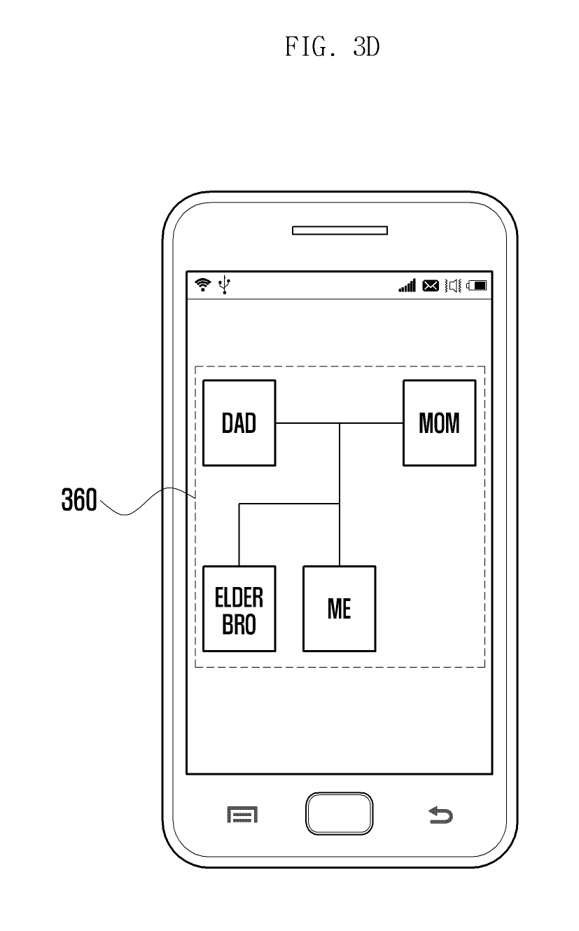

FIG. 2 is a flowchart illustrating the relationship diagram presentation procedure of the phonebook provision method according to an embodiment of the present invention, and FIGS. 3A to 3D are diagrams illustrating exemplary screen images for explaining the procedure of presenting the relationship diagram in the phonebook provision method according to an embodiment of the present invention.

Referring to FIGS. 2 and 3A to 3D, the control unit 170 detects a phonebook application execution request event on the touchscreen 110 (e.g. tap onto the phonebook application icon on the touchscreen).

If the phonebook application execution request event is detected, the control unit 170 reads the phonebook from the storage unit 130 and displays the phonebook on the touch screen 110 in the form of a list at step 201. Here, the control unit 170 is capable of reading the phonebook from an external device (e.g. a cloud server). That is, the first radio communication 140 or the second radio communication unit 150 is capable of connecting to the cloud server to download the phonebook and transfers the phonebook to the control unit 170 under the control of the control unit 170. Due to the display size constraint, it may not be possible to display all of the contact items of the phonebook, but as shown in FIG. 3A, the user can scroll the phonebook to navigate the contact items. If a drag gesture is detected on the touchscreen 170, the control unit 170 scrolls the phonebook in response to the drag gesture to navigate the contact times.

The control unit 170 is monitoring to detect a relationship diagram display request event on the touchscreen 110 at step 202. For example, if the user clicks the menu key 320, the key input unit 120 generates the corresponding key event to the control unit 170. The control unit 170 controls the touchscreen 110 to display the menu 330 as shown in FIG. 3B in response to the key event generated by means of the menu key 320. The user may tap the relationship view button 331 of the menu box 330. If the relationship diagram display request event (e.g. tap on the relationship view button 331) is detected, the control unit 170 controls the touch screen 110 to display the thumbnail images of the per-group relationship diagrams (family, friend, office) as shown in FIG. 3C at step 203.

Next, the control unit 170 may detect an input for selecting (e.g. tapping) one of the thumbnail images, e.g., family relationship diagram thumbnail image 340 on the touchscreen at step 204.

Finally, the control unit 170 reads the family relationship diagram 360 represented by the family relationship diagram thumbnail image 340 from the storage unit 130 and controls the touchscreen 110 to display the family relationship diagram at step 205. The relationship diagram consists of family members icons (e.g. father icon, mother icon, brother icon, and me (user of the apparatus 100) icon in the family relationship diagram 360 as shown in FIG. 3D) linked through lines each other. Of course, the user of the apparatus 100, i.e. me icon, is not necessary to be matched to a contact. Steps 203 and 204 can be omitted. That is, it can be configured such that the family relationship diagram 360 is displayed first. Also, it is possible to configure such that the family relationship diagram 360 is displayed last. Also, it can be possible that only one relationship diagram, e.g. familiar relationship diagram 360, is stored in the storage unit 130. Accordingly, if a relationship diagram display request event (e.g. tap on the relationship view button 331) is detected, the control unit 170 is capable of reading the familiar relationship diagram 360 from the storage unit 130 and controlling the touch screen 110 to display the family relationship diagram 360.

In FIG. 3C, reference number 350 denotes an ‘add’ button for creating a new relationship diagram. The ‘add’ button 350 is selected (e.g. tapped), the control unit 170 controls the touch screen 110 to display a new relationship diagram having no icon (i.e. empty). The control unit 170 is capable of controlling to add icons and connection links, place a call (e.g. voice call), and edit the icons. The control unit 170 is also capable of controlling the touch screen 110 to display a predetermined relationship diagram (e.g. family, office 1, office 2, association 1, association 2, etc.). Such a relationship diagram consists of plural icons and connection lines connecting the icons. That is, the control unit 170 matches the contacts to the acquaintances to create a relationship diagram according to the user's intention. A description is made of the functions in detail with reference to other drawings.

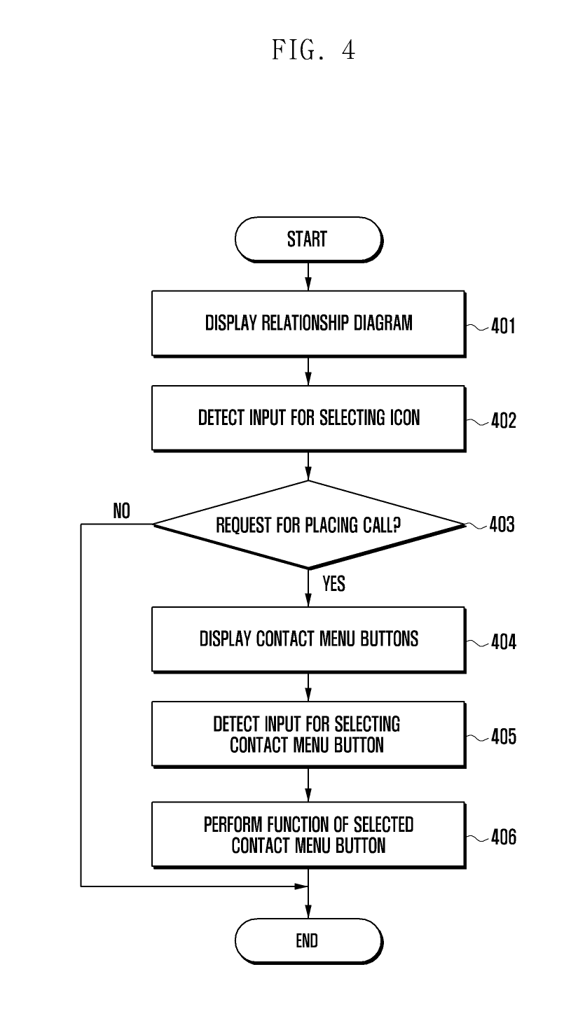

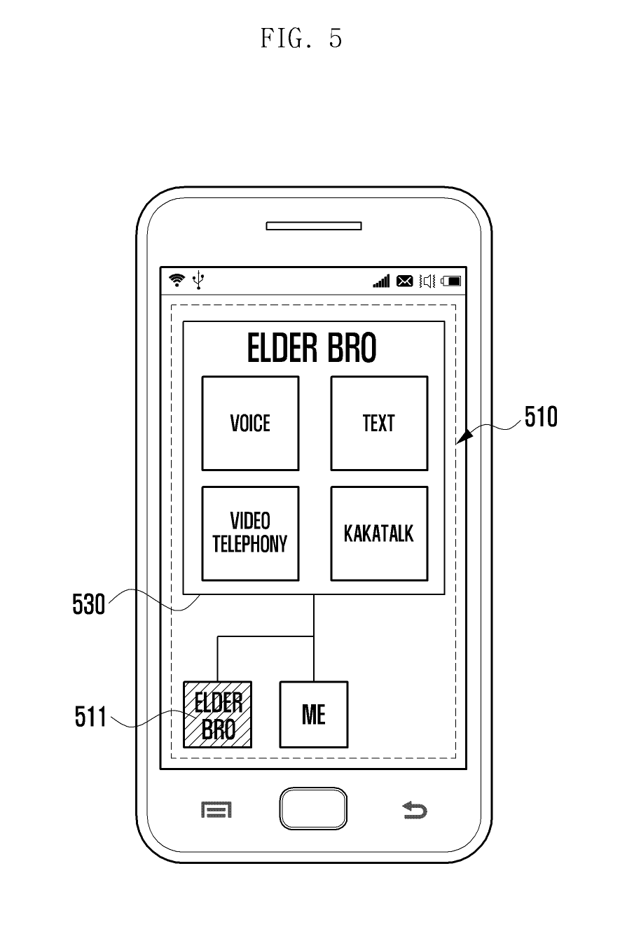

FIG. 4 is a flowchart illustrating the procedure of placing a call using the relationship diagram in the phonebook provision method according to an embodiment of the present invention. FIG. 5 is a diagram illustrating an exemplary screen image for explaining the procedure for placing a call based on relationship diagram in the phonebook provision method according to an embodiment of the present invention.

Referring to FIGS. 4 and 5, the control unit 170 reads the family relationship diagram 510 from the storage unit 130 and controls the touchscreen 110 to display the family relationship diagram 510 at step 401.

The control unit 170 detects a user input for selecting and icon, e.g. ‘brother’ icon 511, on the touchscreen 110 at step 402. The control unit 170 analyzes the user input at step 403. For example, the control unit 170 determines whether the user input is a request for placing a call to the person corresponding to the icon at step 403.

If it is determined that the user input is a request for placing a call, the control unit 170 controls the touchscreen 110 to display a contact menu 530 as shown in FIG. 5 at step 404. For example, the contact menu includes a voice call item, video call item, text message item, and instant messenger item (e.g. KaKao Talk).

The control unit 170 detects a user input for selecting a contact menu item from the contact menu 530 at step 405. Next, the control unit 170 performs a function mapped to the selected contact item at step 406. For example, if the voice call item is selected, the control unit 170 controls one of the first and second radio communication units 140 and 150 to place a call to the terminal corresponding to the contact mapped to the selected icon. If the video call item is selected, the control unit 170 controls one of the first and second radio communication units 140 and 150 to place a video call to the terminal corresponding to the contact mapped to the selected icon. If the text message item or instant messenger item is selected, the control unit 170 controls one of the first and second radio communication units 140 and 150 to transmit a message written by means of the keypad to the terminal corresponding to the contact mapped to the selected icon.

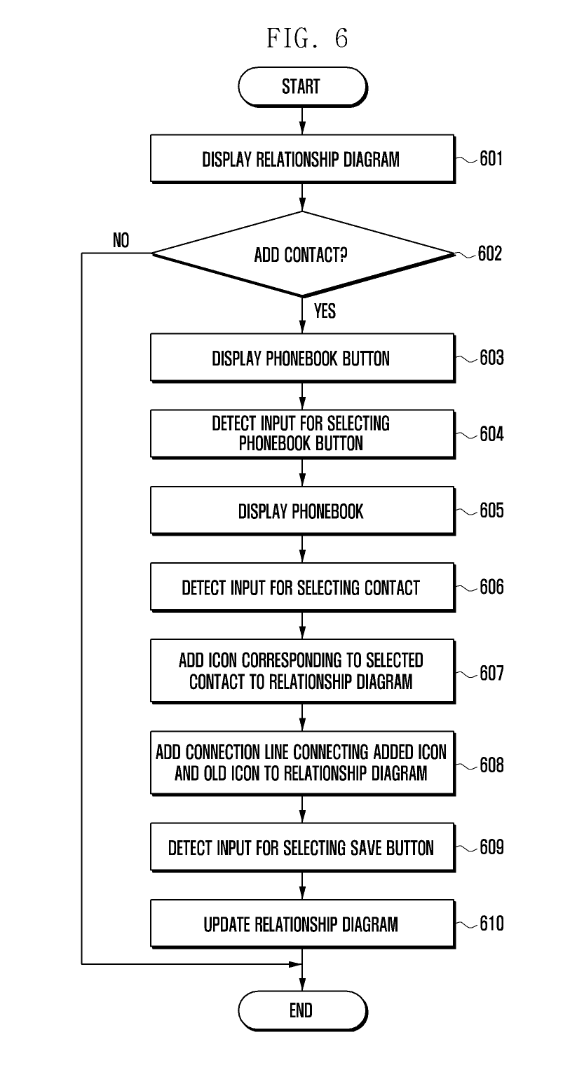

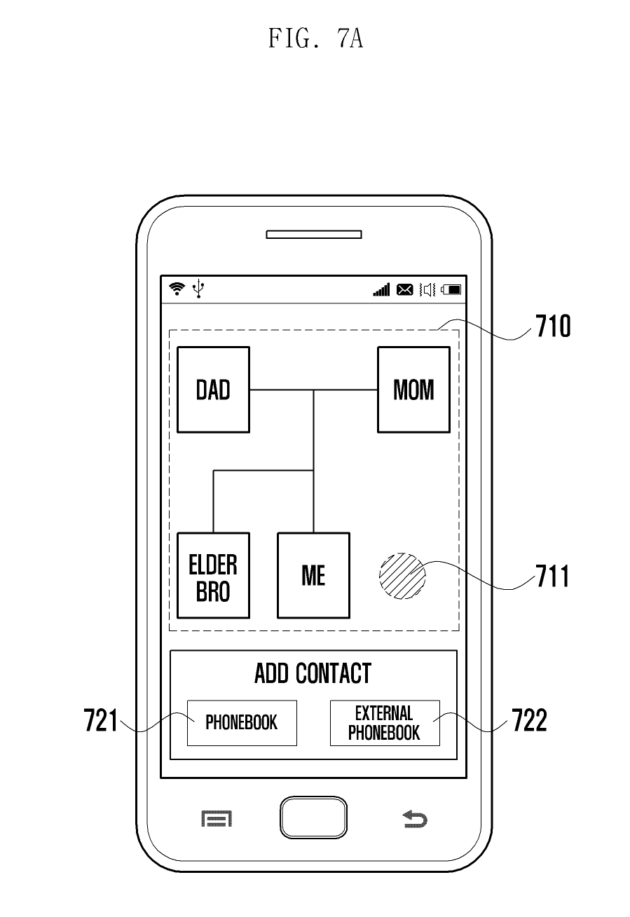

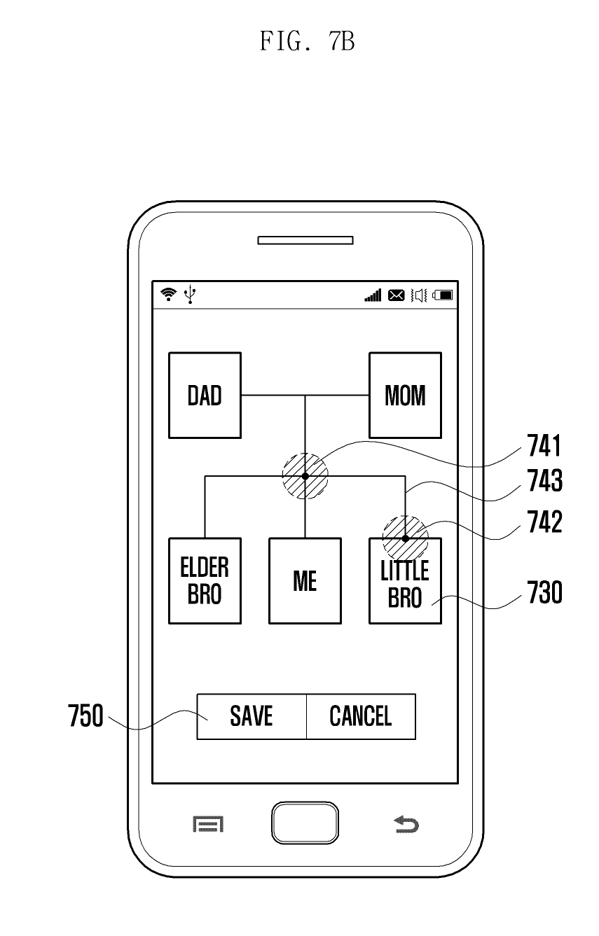

FIG. 6 is a flowchart illustrating the relationship diagram update procedure of the phonebook provision method according to an embodiment of the present invention. FIGS. 7A and 7B are diagrams illustrating exemplary screen images for explaining the relationship diagram update procedure of the phonebook provision method according to an embodiment of the present invention.

Referring to FIGS. 6 and 7A and 7B, the control unit 170 reads a relationship diagram, e.g. family relationship diagram as shown in FIGS. 7A and 7B, from the storage unit 130 and controls the touch screen 110 to display the family relationship diagram 710 at step 601.

The control unit 170 may detect an event for requesting to add a contact (e.g. long tap made on an empty space in the family relationship diagram 170) on the touchscreen 110 at step 602.

If a contact add request event is detected, the control unit 170 controls the touchscreen 110 to display a phonebook item at step 603. The touchscreen 110 may display an internal phonebook item 721 for the phone book stored in the storage unit 130 and an external phonebook item 722 for the phonebook stored in an external device (e.g. cloud server).

The control unit 170 detects a user input for selecting one of the phonebook items, e.g. tap on the internal phone book item 721, on the touch screen 110 at step 604. Of course, the control unit 170 may detect the tap onto the external phonebook item 721 on the touchscreen at step 604.

The control unit 170 controls the touchscreen 110 to display the phone book represented by the selected phonebook item at step 605. The phonebook can be displayed in the form of a list as shown in FIG. 3A. In the case that the selected phonebook item is of the external phonebook, i.e. the phonebook stored in the cloud server, the control unit 170 controls one of the first and second radio communication units 140 and 150 to access the cloud server and download the external phonebook.

Steps 603 and 604 can be omitted. In this case, if the contact add request event is detected, the control unit 170 controls the touchscreen 110 to display the phonebook stored in the storage unit 130 or an external device (e.g. cloud server) at step 605.

The control unit 170 detects a user input (e.g. tap) for selecting a contact item from the phonebook at step 606.

If a contact item is selected, the control unit 170 controls the touch screen 110 to add the icon corresponding to the selected contact item to the relationship diagram at step 607. As shown in FIGS. 7A and 7B, the touchscreen 110 adds the icon 703 at the position where the user has made a long tap 711. The user can enter the title of the icon 730. For example, if the user makes a long tap gesture onto the icon 730, the control unit 170 controls the touchscreen 110 to display a keypad. The touchscreen 100 presents the title, e.g. “little brother,” entered by means of the keypad on the icon 730. The title of the icon 730 can be entered automatically. For example, the name of the contact can be entered as the title of the icon 730 automatically.

The control unit 170 controls the touchscreen 110 to draw a connection line between the added icon 730 and a previous configured icon in the relationship diagram at step 608. As shown in FIG. 7B, if the user makes a tap 741 at a position on the line connecting two icons and then another tap 742 on the icon 730, the control unit 170 creates a connection line 743 connecting the two tapped positions.

The control unit 170 detects a user input for selecting a save button 750 on the touchscreen 110 at step 609. If the save button is selected, the control unit 170 updates the relationship diagram stored in the storage unit 130 with the new one in which the icon 730 and the connection line 743 are added.

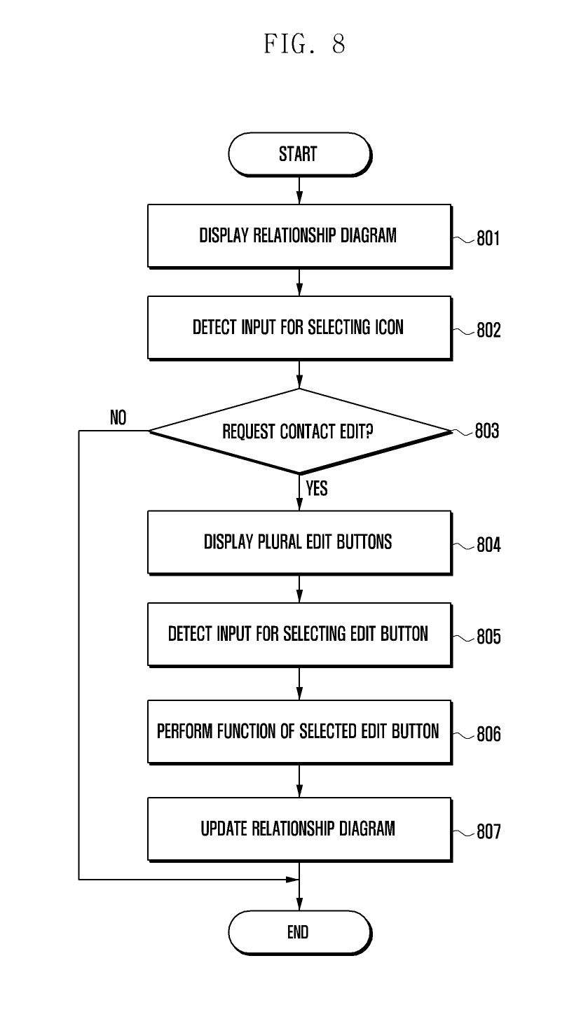

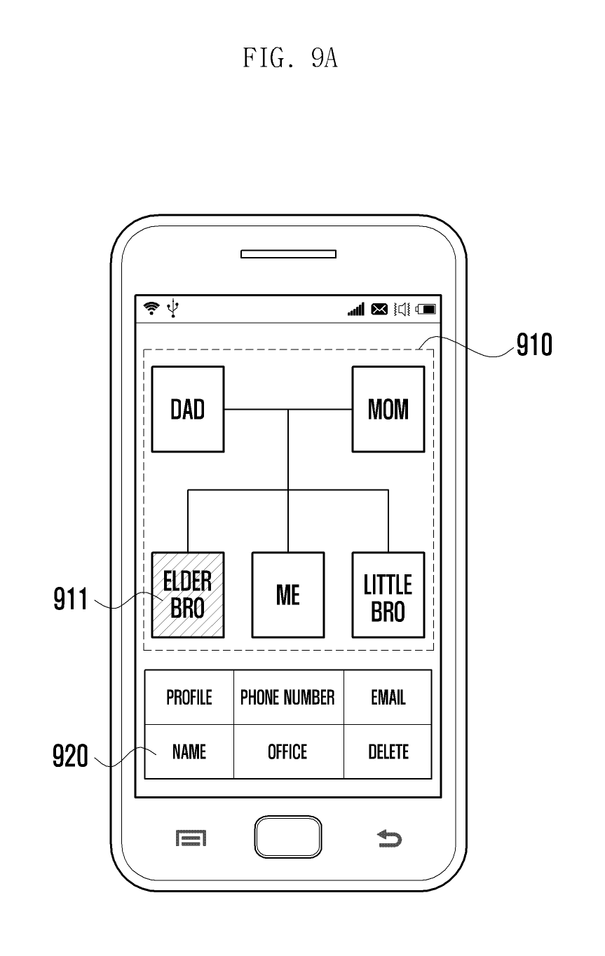

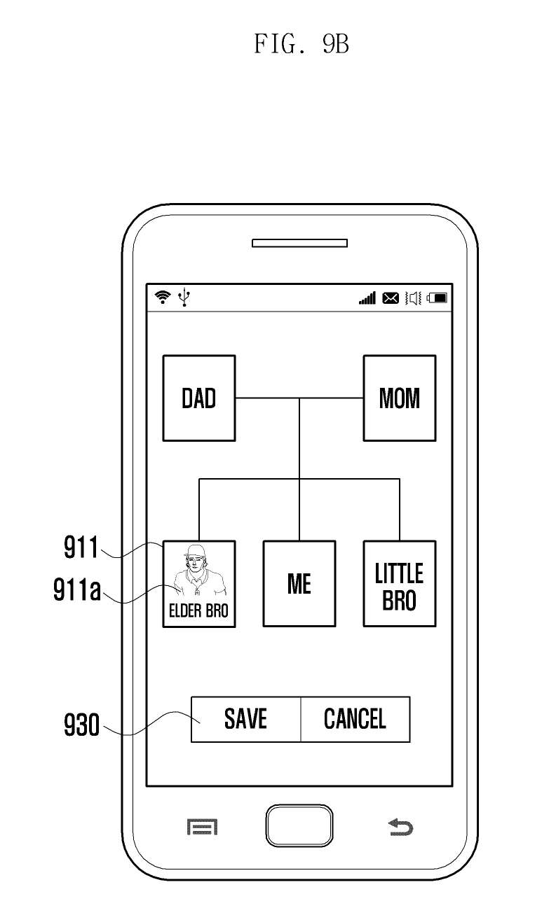

FIG. 8 is a flowchart illustrating a relationship diagram update procedure of the phonebook provision method according to another embodiment of the present invention. FIGS. 9A and 9B are diagrams illustrating exemplary screen images for explaining the relationship diagram update procedure of the phonebook provision method according to another embodiment of the present invention.

Referring to FIGS. 8 and 9A and 9B, the control unit 170 reads a relationship diagram, e.g. family relationship diagram 910 as shown in FIGS. 9A and 9B, from the storage unit 130 and controls the touch screen 110 to display the family relationship diagram 910 at step 601.

The control unit 170 may detect a user input for selecting an icon, e.g. elder brother icon 911 on the touchscreen at step 802. The control unit 170 may determine whether the user input is a contact edit request at step 803. If the user input is made with a long tap, the control unit 170 determines that a contact edit request is input.

If the user input is a contact edit request, the control unit 170 may control the touchscreen 110 to display an edit menu 920 including plural edit menu items as shown in FIG. 9A at step 804.

The control unit 170 may detect a user input for selecting an edit menu item from the edit menu 920 at step 805. Next, the control unit 170 performs the edit function of the selected edit menu item at step 806. For example, if a profile photo add item is selected, the control unit reads a specific image from the storage unit 170 and downsizes the image to be displayed in the form of an elder brother icon 911 on the screen 110 as shown in FIG. 9B.

If the save menu item 930 is selected, the control unit 170 may update the old relationship diagram stored in the storage unit 130 with the new one to which the image 911a is added at step 807.

As described above, the phonebook provision method and apparatus of the present invention may provide the user with the phonebook in the form of relationship diagrams, whereby the user checking the relationships with the acquaintances corresponding to the contacts in the phonebook intuitively.

The phonebook provision method according to the embodiments of the present invention can be recorded in a computer-readable storage media in the form of program commands executable by means of various types of computing means. The computer-readable media may include program commands, data files, data structures, etc. separately or compositely. The program commands recorded in the media may be particularly designed and configured for the present invention, or known and used by those skilled in the computer software field. The computer-readable media may be magnetic media such as a hard disk, a floppy disk and magnetic tape, optical media such as a compact disk read-only memory (CD-ROM) and a digital versatile disk (DVD), magneto-optical media such as floptical disk, and hardware devices such as a ROM, a random-access memory (RAM), a flash memory, etc., particularly implemented to store and execute program commands. Also, the media may be transmission media such as optical or metal lines, waveguides, etc. including carriers delivering signals indicating program commands, data structures, and so on. The program commands may be machine language codes produced by a compiler and high-level language codes that can be executed by computers using an interpreter, etc. In order to perform the operations of the present invention, the hardware devices may be implemented to operate as at least one software module, and vice versa.

The method and apparatus of the present invention is not limited to the above described embodiments but can be practiced with various modifications without departing from the scope of the present invention.

What is claimed is:

1. A phonebook provision method for use in a terminal having a touchscreen, the method comprising:
detecting a first event, the first event being a request for displaying a first relationship diagram, the first relationship diagram including icons corresponding to contacts that are connected through lines; and
displaying the first relationship diagram,
wherein the first relationship diagram is read from a storage unit of the terminal on the touchscreen in response to the first event.

2. The method of claim 1, wherein displaying comprises:
presenting one or more thumbnail images, the one or more thumbnail images including a first thumbnail image corresponding to the first relationship diagram in response to the first event;
detecting an input selecting one of the one or more thumbnail images; and
reading the first relationship diagram corresponding to the first relationship diagram when the selected thumbnail image is the first thumbnail image.

3. The method of claim 1, further comprising:
detecting a second event, the second event being a request for displaying a second relationship diagram, the second relationship diagram including icons corresponding to contacts that are connected through lines; and
displaying the second relationship diagram read from the storage unit of the terminal on the touchscreen in response to the second event, wherein displaying the first and second relationship diagrams comprises:
presenting a first thumbnail image corresponding to the first relationship diagram and a second thumbnail image corresponding to the second relationship diagram;
detecting an input selecting one of the first and second thumbnail image; and
reading one of the first and second relationship diagrams,
wherein the first relationship diagram is read when the first thumbnail image is selected, and wherein the second relationship diagram is read when the second thumbnail image is selected.

4. The method of claim 1, further comprising updating the first relationship diagram with a second relationship diagram.

5. The method of claim 4, wherein updating comprises:
detecting a second event, the second event being a request for adding a new contact on the touchscreen;
displaying a phonebook on the touchscreen in response to the second event;
detecting an input selecting one of the contacts from the phonebook;
adding a new icon corresponding to the selected contact to the first relationship diagram; and
drawing a line connecting the new icon to at least another of the icons of the first relationship diagram.

6. The method of claim 4, wherein updating comprises:
detecting an input for selecting one of the icons on the first relationship diagram;
presenting one or more edit items for editing the selected icon;
detecting an input for selecting at least one of the edit items on the touchscreen; and
performing an edit function of the selected edit item.

7. The method of claim 1, further comprising:
detecting an input for selecting one of the icons in the first relationship diagram on the touchscreen;
displaying one or more contact menu buttons for placing a call to the contact corresponding to the selected icon;
detecting an input for selecting at least one of the contact menu buttons on the touchscreen; and
performing a function corresponding to the selected contact menu button.

8. A terminal comprising:
a touchscreen;
a storage unit which stores one or more contacts and at least one relationship diagram including icons corresponding to the contacts that are connected through lines;
a radio communication unit which establishes a communication link with another terminal represented by one of the contacts corresponding to one of the icons when selected by the user; and
a control unit which controls the touch screen, the storage unit, and the radio communication unit,
wherein the control unit controls detecting a first event requesting for displaying the at least one relationship diagram and displaying the at least one relationship diagram read from the storage unit of the terminal on the touchscreen in response to the first event.

9. The terminal of claim 8, wherein the control unit controls presenting a thumbnail image corresponding to the relationship diagram in response to the first event, detecting an input selecting the thumbnail image, and reading the relationship diagram corresponding to the selected thumbnail image.

10. The terminal of claim 8, wherein the control unit controls updating the first relationship diagram with a second relationship diagram.

11. The terminal of claim 10, wherein the control unit controls detecting a second event requesting for adding a contact on the touchscreen, displaying a phonebook including the contacts on the touchscreen in response to the second event, detecting an input selecting one of the contacts from the phonebook, adding a new icon corresponding to the selected contact to the first relationship diagram, and drawing a line connecting the new icon with at least one other icon.

12. The terminal of claim 10, wherein the control unit controls detecting an input for selecting one of the icons on the first relationship diagram, presenting at least one edit item for editing the selected icon, detecting an input for selecting an edit item on the touchscreen, and performing an edit function of the selected edit item.

13. The terminal of claim 8, wherein the control unit controls detecting an input for selecting one of the icons in the first relationship diagram on the touchscreen, displaying at least one contact menu item for placing a call to the contact corresponding to the selected icon, detecting an input for selecting a contact menu button on the touchscreen, and performing a function corresponding to the selected contact menu button.
